(19) United States
(12) Patent Application Publication
(10) Pub. No.: US 2005/0135001 A1
(43) Pub. Date: Jun. 23, 2005

(54) Magnetic recording device

(75) Inventor: Yasushi Endo, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/015,027

(22) Filed: Dec. 20, 2004

(30) Foreign Application Priority Data
Dec. 19, 2003 (JP) 422777/2003

(51) Int. Cl. G11B 5/55

(52) U.S. Cl. 360/97.02; 360/266

(57) ABSTRACT

Plate-shaped rectifying plates 50, the area of which that corresponds to the part of a body spring 20 from the tip thereof to an elastic bending portion 31 thereof being opened, are respectively provided to proximal portions 30 of upper and lower suspensions 17 and 18 carrying heads 26 of a magnetic recording device. Thereby, when recording and reproducing onto and from a disk 2 are performed by the magnetic recording device, stable recording and reproducing onto and from the disk 2 is enabled, by reducing the variation in height of each head 26 from the surface of the disk 2 by utilizing the airflow flowing across the disk 2 by means of the rectifying plate 50.

### BACKGROUND OF THE INVENTION

1. Field of the Invention

The present invention relates to a magnetic recording device for a magnetic disk cartridge, which contains a discoid magnetic disk in a casing, the magnetic recording device performing recording and reproducing onto and from the magnetic disk.

2. Description of the Related Art

Recently, as electronic devices such as digital cameras, digital video cameras, notebook computers, and the like spread rapidly, various kinds of recording media (hereinafter referred to as media), which are used in such devices, have been proposed and put to practical use. As for these media, it is desired to realize media, which are small and inexpensive and have a large capacity, in view of portability, convenience, economy, and the like.

As media which are currently put to practical use, various types of the media such as those of the semiconductor memory type, hard-disk type, magneto-optical disk type, magnetic disk type, and the like can be listed. Among these types, the semiconductor memories are small and easy to handle, and have a reasonable large capacity, and are therefore the most popular. However, the semiconductor memories have a problem that they are relatively expensive. In addition, as those of the hard-disk type, those having capacities of 340 MB or 1 GB are known. However, these also have a problem that they are expensive. On the other hand, those of the magneto-optical disk type are relatively inexpensive, and have a large capacity for their sizes. For example, as for MO cartridges, those having capacities of 128 MB to 1.3 GB are currently available. However, the magneto-optical disks have a problem that the recording speed is slow because the write time is long.

In view of such problems, as media, which are small and inexpensive and have a large capacity, and which can store data of personal computers or data photographed by use of digital cameras as they are and which can be freely handed to other people, magnetic disk cartridges such as “click! (Registered Trademark),” which is described in U.S. Patent Application Publication No. 20010763014, have been put to practical use. The click! (Registered Trademark) is that which rotatably contains a flexible magnetic disk, which is fixedly retained on a center core, in a housing with the size of about 50 mm×55 mm×2 mm, and which has a capacity of 40 MB.

In addition, as a recording/reproducing drive (magnetic recording device) for the click! (Registered Trademark), there exists a Type II PC card drive in addition to a drive which can be connected to equipment such as personal computers via USB. The PC card drive has a size of about 53 mm×85 mm×5 mm, and the whole of the drive can be inserted into a PC card slot of a personal computer or the like.

As described above, the click! (Registered Trademark) magnetic cartridge has the excellent portability and convenience among currently available media, and the media are inexpensive. For this reason, this is a medium which has been capturing attention in recently.

Incidentally, in the click! (Registered Trademark) magnetic cartridge or the like described above, the recording and reproducing of signals onto and from the magnetic disk are performed by use of an actuator provided to the drive. This actuator is generally constituted of a carriage, a suspension attached to the front end of the carriage, a magnetic head attached to the tip of the suspension, a movable coil of a voice coil motor attached to the rear end of the carriage, and a stationary magnet of the voice coil motor that rotates the carriage. The magnetic head is kept in a state where the magnetic head floats slightly above the magnetic disk. When small oscillations such as variation in height of flying, pitching, rolling, and yawing occur in the magnetic head, and the state of slight flotation fluctuates, a phase shift of signal, a slight loss of signal or the like occurs, thereby causing failure of a writing signal or a read-out signal. The faster the rotation speed of the magnetic disk becomes, the more prominently such phenomena occur, because change in airflow between an opening portion of the magnetic disk cartridge for allowing the magnetic head to access the disk therethrough and portions other than this opening portion occurs.

Especially in recent years, for the purpose of increasing the recording capacity of the magnetic disk cartridge, the increasing of track density (the increasing of the TPI), the increasing of linear density (the increasing of the BPI), and the like have been made. Accordingly, if such fluctuations in the state of slight flotation of the magnetic head occur during recording and reproducing onto and from the magnetic disk, which has increased capacity by the increasing of the TPI and BPI as described above, the reliability of data is seriously affected.

### SUMMARY OF THE INVENTION

The present invention has been made in consideration of the problems described above. An object of the present invention is to provide a magnetic recording device capable of stably recording and reproducing onto and from magnetic disks.

A magnetic recording device according to the present invention is a magnetic recording device for performing recording and reproducing onto and from a discoid magnetic disk by means of a magnetic head on a swing-arm-type actuator, wherein the actuator includes: a carriage; a suspension attached to the front end of the carriage; the magnetic head attached to the tip of the suspension; and a rectifying plate for rectifying airflow flowing across the magnetic disk caused when the magnetic disk rotates, the rectifying plate extending around at least part of the periphery of the magnetic head and the suspension.

In the present invention, the rectifying plate may be disposed in a manner such that the rectifying plate surrounds both sides of the suspension and the tip of the magnetic head. Alternatively, the rectifying plate may be disposed along one side of the suspension and the tip of the magnetic head.

Additionally, the rectifying plate maybe fixed to the carriage. Alternatively, the rectifying plate may be fixed on a carriage-side proximal portion of the suspension.

Additionally, the rectifying plate may be provided with a cleaning member for removing dust on the magnetic disk, in a portion of the rectifying plate facing the magnetic disk.

In the magnetic recording device according to the present invention, it is preferable that the revolution speed of the magnetic disk be 2000 to 8000 rpm.

The magnetic recording device according to the present invention is particularly effective in a case where a magnetic disk cartridge, in which the area of an opening portion, through which the magnetic head accesses the disk, is 10% to 50% of the effective area of the magnetic disk (the area which can be accessed by the magnetic head).

With the magnetic recording device according to the present invention, as a result of providing, around at least part of the periphery of a magnetic head and suspension of a swing-arm-type actuator, a rectifying plate for rectifying airflow flowing across a magnetic disk when the magnetic disk rotates, it is possible to reduce the variation in the relative position of the magnetic head from the surface of the magnetic disk by utilizing the airflow that flows across the upper and lower surfaces of the rectifying plate, when airflow is rectified with the rectifying plate. Accordingly, stable recording and reproducing onto and from the magnetic disk is enabled.

Particularly in a recording and reproducing system using a removable flexible-magnetic disk cartridge, a configuration in which the magnetic disk cartridge has an head access opening, the area of which is relatively large (for example, 20% to 60% of the entire recording area of the magnetic disk), and a shutter capable of opening and closing the access opening, is adopted. Since the head access opening is left opened during recording and reproducing, the fluctuation in the airflow flowing across the magnetic disk necessarily occurs between the access opening and portions other than the opening. Such changes in the airflow can be effectively suppressed, by the rectifying plate of the magnetic recording device according to the present invention. As a result of this, the variation in the relative position of the magnetic head from the surface of the magnetic disk is reduced, and stable recording and reproducing can be achieved.

### BRIEF DESCRIPTION OF THE DRAWINGS

FIG. 1 is an exploded perspective view showing a card-type magnetic recording device of an embodiment according to the present invention, and a cartridge to be inserted into the device.

FIG. 2 is a diagram showing an inside of the card-type magnetic recording device with an upper cover thereof removed.

FIG. 3 is a perspective view of an actuator and a load ramp included in the card-type magnetic recording device.

FIG. 4 is a cross section of the actuator of the card-type magnetic recording device viewed from the side thereof (from the direction of the arrow C in FIG. 3).

FIG. 5 is a top view of the card-type magnetic recording device with a head thereof accessing a disk.

FIGS. 6A and 6B are perspective views of actuators of card-type magnetic recording devices according to other aspects of the present invention.

FIGS. 7A and 7B are top views of card-type magnetic recording devices according to other aspects of the present invention, with heads thereof accessing disks.

FIG. 8 is a cross section of a head portion of a card-type magnetic recording device according to another aspect of the present invention.

### DESCRIPTION OF THE PREFERRED EMBODIMENTS

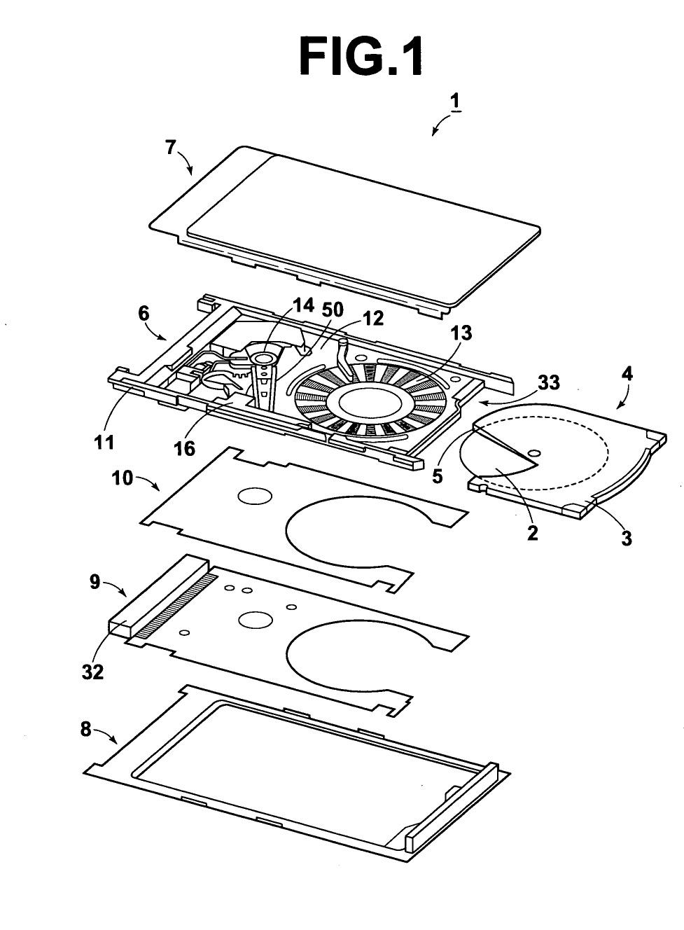

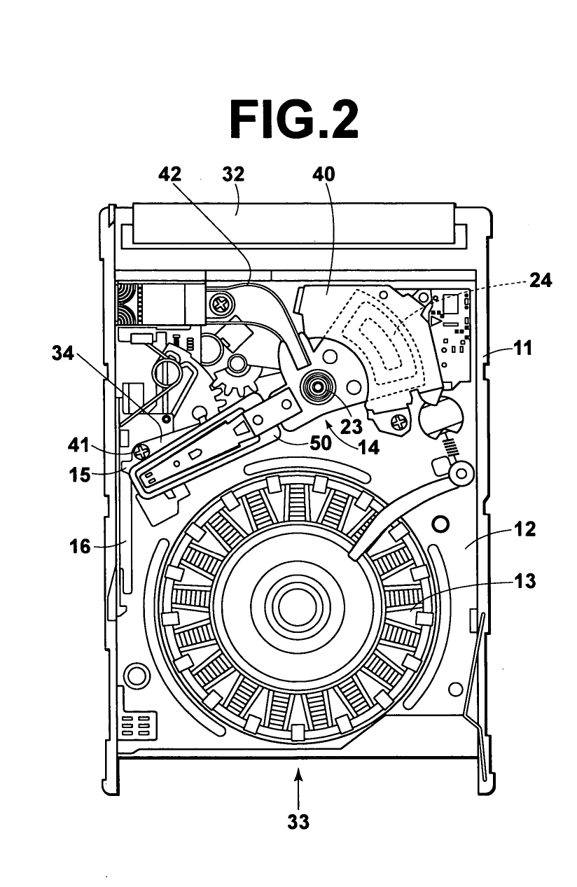

FIG. 1 is an exploded perspective view showing a card-type magnetic recording device 1, which is compliant with the PCMCIA type II standard, and a disk 2. FIG. 2 is a plan view of the card-type magnetic recording device 1 with an upper cover thereof removed.

The discoid magnetic recording medium (hereinafter referred to as disk) 2 is contained in a shell 3, to become a cartridge 4. The shell 3 is provided with a shutter 5. Although constantly urged toward a closing direction, the shutter 5 is opened by the operation of loading the cartridge 4 into the magnetic recording device 1 through an insertion opening 33 (the opened state is shown in FIG. 1).

The magnetic recording device 1 includes a main body 6, the upper cover 7, a lower cover 8, and an information processing unit 9. An insulation sheet 10 is disposed between the main body 6 and the information processing unit 9.

Both of the upper cover 7 and the lower cover 8 are formed by press working of thin plates of stainless steel, and are attached to upper and lower surfaces of the main body 6 by means of engagement and adhesion.

The main body 6 is constituted of parts including a peripheral frame 11 made of synthetic resin, a frame plate 12 which is outsert molded integrally with the peripheral frame 11, a spindle motor 13 mounted on the frame plate 12, an actuator 14, a load ramp 15, and an ejection mechanism 16. The spindle motor 13 drives the disk 2.

The information processing unit 9 is obtained by mounting various elements and packages on a circuit board as well as providing an input/output unit thereto. The information processing unit 9 controls reading-out and writing of information from and onto the disk 2, processing of information, and driving of the spindle motor 13 and the actuator 14. The magnetic recording device 1 and the information processing unit 9 are connected via a connector 32.

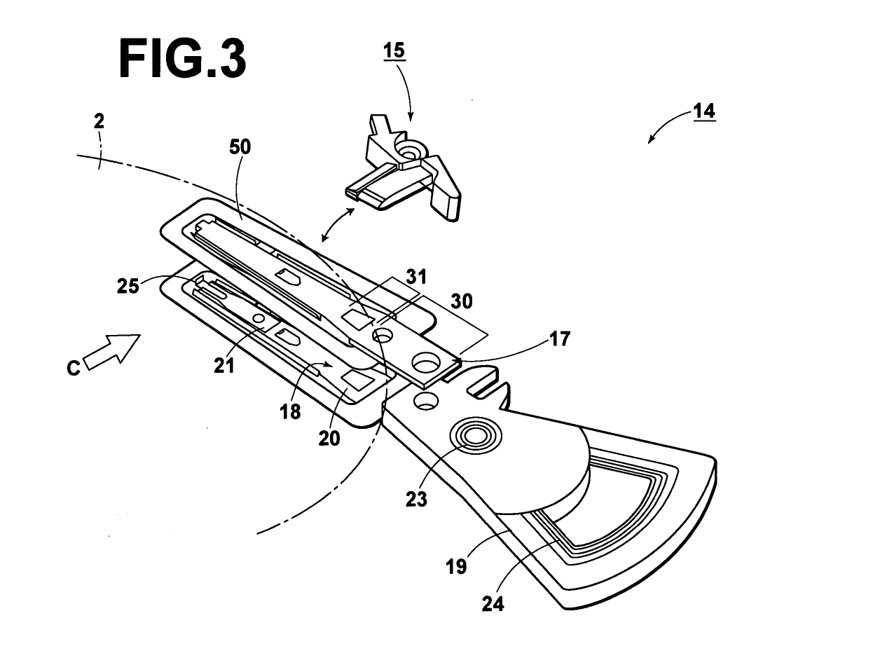

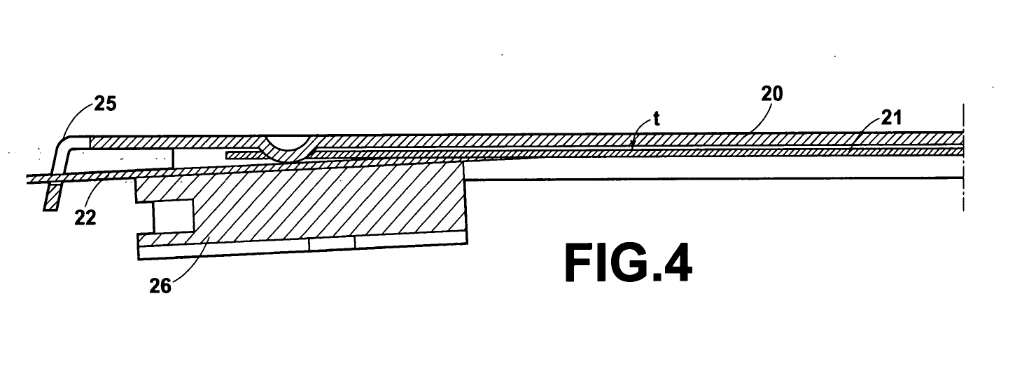

A description will be given of the structure of the actuator 14 with reference to FIGS. 3 and 4. Incidentally, a rectifying plate 50 is omitted in FIG. 4.

The actuator 14 is generally constituted of a carriage 19, upper and lower suspensions 17 and 18 attached to the front end of the carriage 19, magnetic heads 26 attached to the tips of the upper and lower suspensions 17 and 18 respectively, a movable coil 24 of a voice coil motor attached to the rear end of the carriage 19, and a stationary magnet (not shown) of the voice coil motor which rotates the carriage 19.

The carriage 19 is a molded component made of hard resin and is rotatably attached to the frame plate 12 around a shaft 23. The actuator 14 includes the upper and lower suspensions 17 and 18, which are fixed by means of the carriage 19 in such a way that they face each other. Accordingly, the upper and lower suspensions 17 and 18 are synchronously rotated around the shaft 23 of the carriage 19, and reading-out and writing of information from and onto a single side or both sides of the disk 2 are performed.

The carriage 19 is also equipped with the movable coil 24 of the voice coil motor. The movable coil 24 is used to drive the head to an access position. For the movement from the access position to a retraction position, the elasticity of a returning spring (not shown) is utilized. A spring, which is employed in the ejection mechanism, also functions as the returning spring.

The upper and lower suspensions 17 and 18 have same structure. As shown in FIG. 4, each of these upper and lower suspensions 17 and 18 is constituted of a body spring 20, a supporting spring 21, and a gimbal portion 22.

The body spring 20 is a substantially planar narrow plate which is formed by press working of a thin plate of stainless steel, with an elastic bending portion 31 (FIG. 3) formed in the middle thereof.

The supporting spring 21 is attached to the distal portion of the body spring 20. Additionally, the gimbal portion 22 is formed at the tip portion of the supporting spring 21, by stamping with a press. The protruding tip portion of this gimbal portion 22 is fitted into an engagement hole 25 by insertion, the engagement hole 25 being provided at the tip of the body spring 20.

The magnetic head (hereinafter referred to as head) 26 for recording and reproducing is adhered to the middle portion of the gimbal portion 22.

Additionally, plate-shaped rectifying plates 50, the area of which that corresponds to the part of the body spring 20 from the tip to the elastic bending portion 31 thereof being opened, are respectively fixed to proximal portions 30 of the upper and lower suspensions 17 and 18. The rectifying plate 50 is provided so that it is set parallel to the surface of the disk 2. The rectifying plate 50 is provided in order to reduce the variation in height of each head 26 from the surface of the disk 2 by rectifying the airflow caused by the rotation of the disk 2 and utilizing the airflow flowing across the upper and lower surfaces of the rectifying plate 50.

The load ramp 15 is fixed to the frame plate 12 as shown in FIG. 2.

Next, a description will be given of an operation of the magnetic recording device 1 of the present embodiment.

When the cartridge 4 is inserted through the insertion opening 33 of the magnetic recording device 1, the shutter 5 of the shell 3 is opened by the movement made when the cartridge 4 is inserted. The shell 3 is positioned over the upper face of the spindle motor 13, and the disk 2 contained therein is driven to rotate by the motor 13. Thereafter, the carriage 19 is rotated around the shaft 23, and the heads 26 on the tip thereof move from the retraction position to an access position to perform reading-out and writing of information from and onto the disk 2.

When the reading-out and writing of information from and onto the disk 2 are completed, the head 26 starts moving toward the load ramp 15. Thereafter, the retraction position is reached where the upper and lower suspensions 17 and 18 sandwich the load ramp 15, and the actuator 14 stands by in this position.

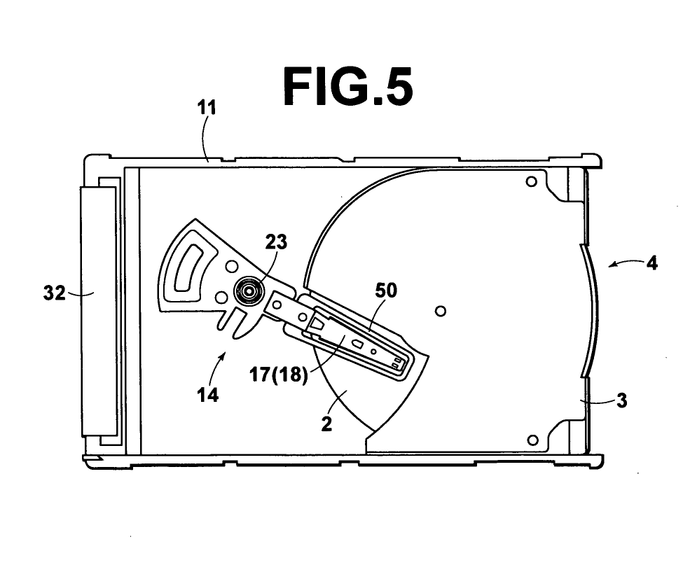

As shown in FIG. 5, when the upper and lower suspensions 17 and 18 are in a position to access the disk, it is possible to reduce the variation in height of the heads 26 from the surfaces of the disk 2, the heads 26 attached to the tips of the upper and lower suspensions 17 and 18 respectively, by rectifying the airflow flowing across the disk 2 caused when the disk 2 rotates by the use of the rectifying plates 50 fixed to the proximal portions 30, and by utilizing the airflow flowing across the upper and lower surfaces of each rectifying plate 50. Accordingly, stable recording and reproducing onto and from the disk 2 is enabled.

When the recording and reproducing are completed, the magnetic excitation of the movable coil 24 is released, and the upper and lower suspensions 17 and 18 are returned to the retraction position by the returning spring.

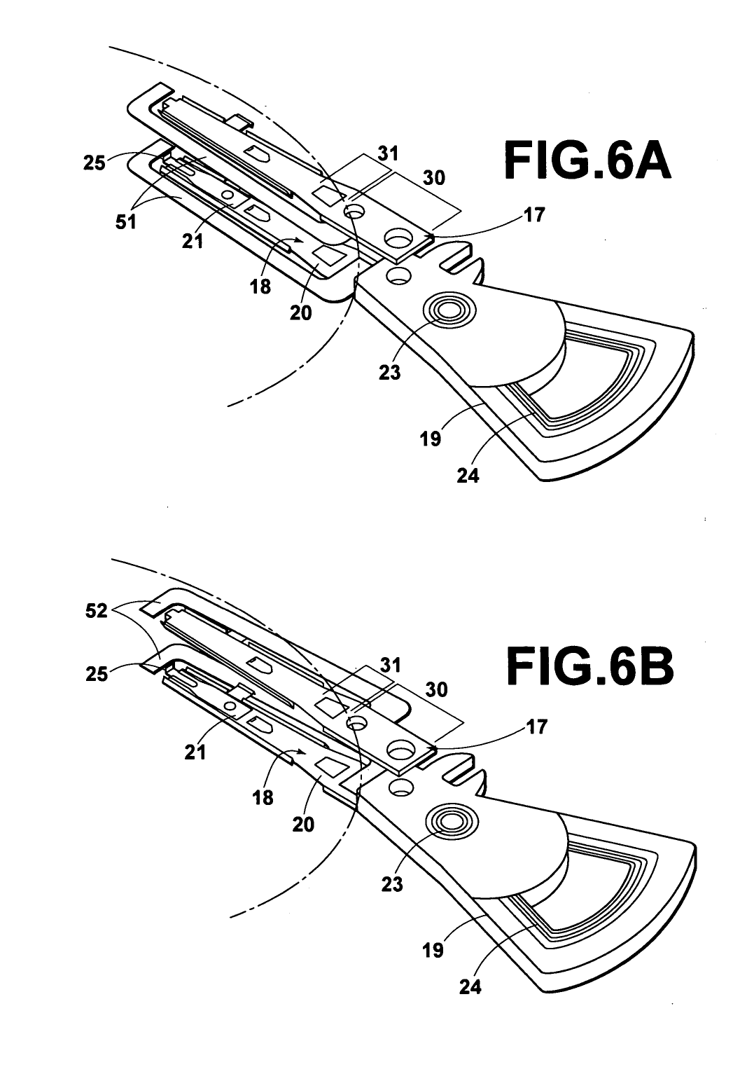

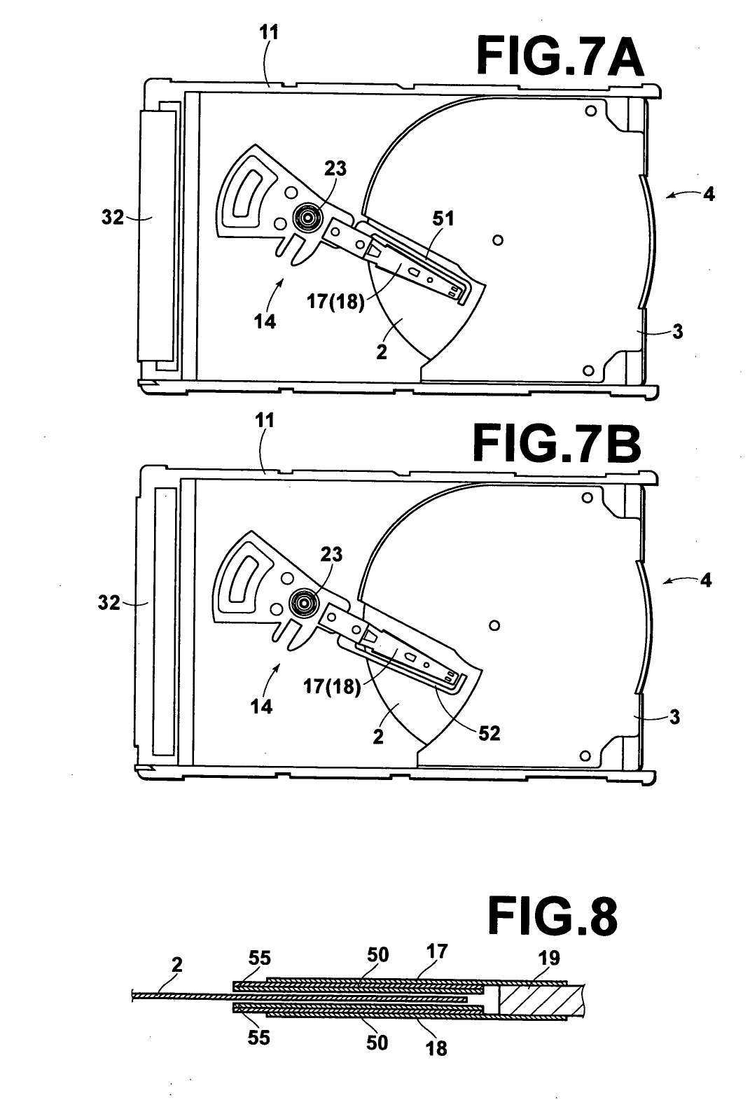

While the preferred embodiment of the present invention has been described hereinbefore, the present invention is not limited to the above described embodiment. As shown in FIGS. 6 and 7, the shape of the rectifying plate 50 may be such a form that the plate is disposed only around the tip and one side of each of the upper and lower suspensions 17 and 18 (the rectifying plate 51 or 52). In addition, the size and shape thereof can be optionally changed. Moreover, the rectifying plate 50 may be fixed to the carriage 19.

Furthermore, as shown in FIG. 8, cleaning members 55 may be provided to surfaces of the rectifying plates 50, the surfaces facing the disk 2. The cleaning member 55 has a contacting surface portion formed of a material which does not cause scratches on the surface of the disk 2 and does not produce lint to become dust, for example, a nonwoven fabric, a filament fabric, a raised fabric, a fiber brush, or the like. Alternatively, the whole cleaning member may be made of one of the above materials. The cleaning member may be fabricated by fixing one of the above materials on the surface of a soft member made of plastic, rubber, or the like. Alternatively, it is possible to provide a cleaning member to remove dust in a scratching manner by the use of a hard ceramic member. Incidentally, the cleaning member 55 may be provided onto the entire surface of the rectifying plate 50, or may be provided thereto partially.

By providing the rectifying plate 50 with such cleaning member 55, same effects as those of the above described embodiment can be obtained, and at the same time, prevention of dropouts caused by such dust and the like from occurring is enabled, because the cleaning member 55 is in contact with the surface of the disk 2 to perform wiping, and removes the dust or the like adhering to the surface of the disk 2.

1. A magnetic recording device for performing recording and reproducing onto and from a discoidmagnetic disk by means of a magnetic head on a swing-arm-type actuator,
wherein the actuator comprises: a carriage; a suspension attached to the front end of the carriage; the magnetic head attached to the tip of the suspension; and a rectifying plate for rectifying airflow flowing across the magnetic disk caused when the magnetic disk rotates, the rectifying plate extending around at least part of the periphery of the magnetic head and the suspension.

2. The magnetic recording device according to claim 1, wherein the rectifying plate is disposed in a way that the rectifying plate surrounds both sides of the suspension and the tip of the magnetic head.

3. The magnetic recording device according to claim 1, wherein the rectifying plate is disposed along one side of the suspension and the tip of the magnetic head.

4. The magnetic recording device according to claim 1, wherein the rectifying plate is fixed to the carriage.

5. The magnetic recording device according to claim 2, wherein the rectifying plate is fixed to the carriage.

6. The magnetic recording device according to claim 3, wherein the rectifying plate is fixed to the carriage.

7. The magnetic recording device according to claim 1, wherein the rectifying plate is fixed on a carriage-side proximal portion of the suspension.

8. The magnetic recording device according to claim 2, wherein the rectifying plate is fixed on a carriage-side proximal portion of the suspension.

9. The magnetic recording device according to claim 3, wherein the rectifying plate is fixed on a carriage-side proximal portion of the suspension.

10. The magnetic recording device according to claim 1, wherein the rectifying plate is provided with a cleaning member for removing dust on the magnetic disk, in a portion facing the magnetic disk.

11. The magnetic recording device according to claim 2, wherein the rectifying plate is provided with a cleaning member for removing dust on the magnetic disk, in a portion facing the magnetic disk.

12. The magnetic recording device according to claim 3, wherein the rectifying plate is provided with a cleaning member for removing dust on the magnetic disk, in a portion facing the magnetic disk.

13. The magnetic recording device according to claim 4, wherein the rectifying plate is provided with a cleaning member for removing dust on the magnetic disk, in a portion facing the magnetic disk.

14. The magnetic recording device according to claim 5, wherein the rectifying plate is provided with a cleaning member for removing dust on the magnetic disk, in a portion facing the magnetic disk.

15. The magnetic recording device according to claim 6, wherein the rectifying plate is provided with a cleaning member for removing dust on the magnetic disk, in a portion facing the magnetic disk.

16. The magnetic recording device according to claim 7, wherein the rectifying plate is provided with a cleaning member for removing dust on the magnetic disk, in a portion facing the magnetic disk.

17. The magnetic recording device according to claim 8, wherein the rectifying plate is provided with a cleaning member for removing dust on the magnetic disk, in a portion facing the magnetic disk.

18. The magnetic recording device according to claim 9, wherein the rectifying plate is provided with a cleaning member for removing dust on the magnetic disk, in a portion facing the magnetic disk.
